(19) United States
(12) Patent Application Publication
(10) Pub. No.: US 2008/0306785 A1
(43) Pub. Date: Dec. 11, 2008

(54) APPARATUS AND METHODS FOR OPTIMIZING SUPPLY CHAIN CONFIGURATIONS

(75) Inventors: Francesca SCHULER, DesPlaines, IL (US); Thomas S. Babin, Lake Zurich, IL (US); Jin Liu, Palatine, IL (US); Andreas Schaller, Wiesbaden (DE); Mansour Toloo, North York (CA); Chi Zhou, Chicago, IL (US)

Correspondence Address: PRASS LLP, 2661 Riva Road, Bldg. 1000, Suite 1044, ANNAPOLIS, MD, 21401, US

(73) Assignee: Motorola, Inc., Schaumburg, IL (US)

(21) Appl. No.: 11/760,132

(22) Filed: Jun. 8, 2007

(51) Int. Cl. G06F 9/44

(52) U.S. Cl. 705/7

(57) ABSTRACT

A machine-implemented method for optimizing a supply chain configuration may include retrieving a supply chain configuration and financial requirements for a product, receiving user input to optimize the supply chain configuration, and outputting at least one most profitable scenario over a desired time period.

### TECHNICAL FIELD

The present invention is directed to supply chain cost models. More particularly, the present invention is directed to methods and apparatuses for optimizing supply chain cost models.

### BACKGROUND

A supply chain involves coordination of elements along a value chain providing goods and services in correct quantities, to appropriate locations, and at the right time in order to satisfy service level requests while minimizing system-wide costs.

From a strategic viewpoint, supply chain organizations require tools that aid in the understanding the end-to-end supply chain costs and the impact of varying parameters such as product demand, changes in manufacturing/distribution center sourcing networks, market strategies (e.g., tax/duty structures), manufacturing strategies (e.g., efficient, lean, detailed, etc.), distribution strategies (e.g., order processing mechanisms, ABC classification, etc.), pricing strategies, transportation networks, and logistics networks. Optimizing these parameters ensures that new product information financial performance and projected financial performance for existing products are maximized.

Some conventional approaches to supply chain configuration/design evaluate end-to-end supply chain costs and product margins after the products are already released to manufacturing. Therefore, product design changes and supply chain configuration changes including supplier changes, manufacturing and/or distribution center sourcing network changes, etc. that could reduce distribution costs and manufacturing costs are evaluated too late in the product's lifecycle, negatively impacting projected product margins.

When supply chain networks increase is size, the complexity of the network increases, resulting in a substantial number of combination or possibilities for manufacturing and distribution center. Understanding all possible combinations and manually entering combinations into the supply chain cost model to find a scenario that maximizes profitability can be a tedious, time-consuming process. In addition, because of the large number of possibilities, an optimized scenario may never be realized manually.

Thus, it may be desirable to provide methods and apparatuses for analyzing and optimizing a supply chain cost model via automated cross-scenario comparisons, sensitivity analysis, and auto-scenario selection. It may be desirable to provide methods and apparatuses for recommending changes to domains of a supply chain cost model to satisfy supply chain financial performance goals. The methods and apparatuses may support optimization based on margin, cost, and net sales after discount, for example, by varying supply chain strategies.

### SUMMARY OF THE INVENTION

According to various aspects of the disclosure, a machine-implemented method for optimizing a supply chain configuration may comprise retrieving a supply chain configuration and financial requirements for a product, receiving user input to optimize the supply chain configuration, and outputting at least one most profitable scenario over a desired time period.

In accordance with some aspects of the disclosure, a processing device may comprise at least one processor, a memory, and a bus. The memory may include instructions for the processor, and the bus may provide communication between the processor and the memory. The memory may further comprise instructions for retrieving a supply chain configuration and financial requirements for a product, receiving user input to optimize the supply chain configuration, and outputting at least one most profitable scenario over a desired time period.

According to some aspects of the disclosure, a tangible, machine-readable medium may include instructions for at least one processor recorded thereon. The medium may comprise instructions for retrieving a supply chain configuration and financial requirements for a product, instructions for receiving user input to optimize the supply chain configuration, and instructions for outputting at least one most profitable scenario over a desired time period.

### BRIEF DESCRIPTION OF THE DRAWINGS

In order to describe the manner in which the above-recited and other advantages and features of the invention can be obtained, a more particular description of the invention briefly described above will be rendered by reference to specific embodiments thereof which are illustrated in the appended drawings. Understanding that these drawings depict only typical embodiments of the invention and are not therefore to be considered to be limiting of its scope, the invention will be described and explained with additional specificity and detail through the use of the accompanying drawings in which:

FIG. 1 illustrates a block diagram of a computer system having an exemplary supply chain optimization module in accordance with a possible embodiment of the invention;

FIG. 2 illustrates a block diagram of exemplary inputs to and outputs from a cost calculation engine in accordance with a possible embodiment of the invention;

FIG. 3 illustrates a block diagram of an exemplary supply chain cost model in accordance with a possible embodiment of the invention;

FIGS. 4A-4C illustrate block diagrams of supply chain cost models including exemplary supply chain optimization modules having varying optimization modes in accordance with possible embodiments of the invention; and

FIG. 5 is an exemplary flowchart illustrating an exemplary supply chain optimization process in accordance with one possible embodiment of the invention.

### DETAILED DESCRIPTION

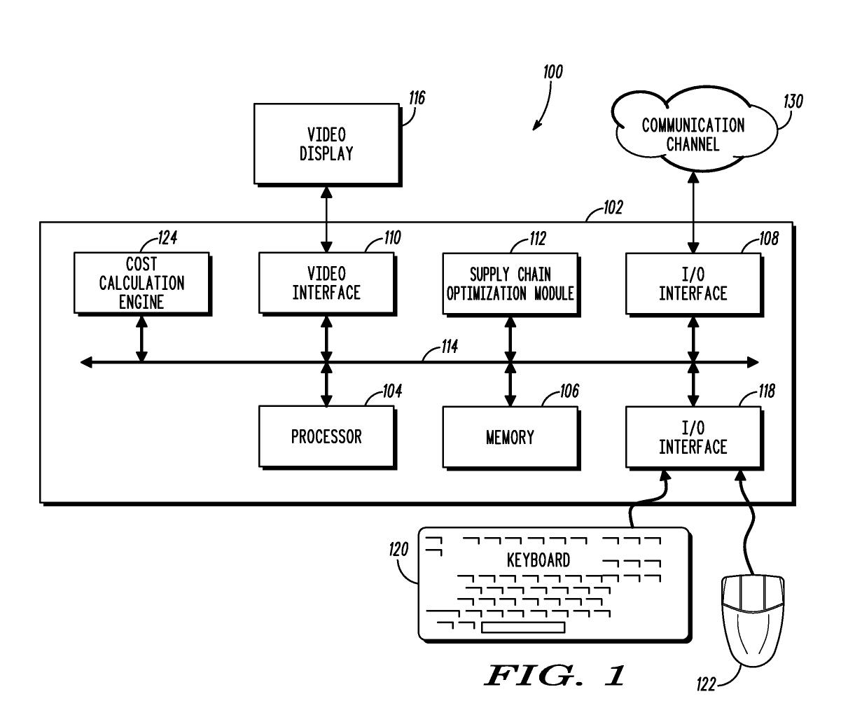

FIG. 1 illustrates a block diagram of an exemplary computer system 100 having a supply chain optimization module 112 in accordance with a possible embodiment of the invention. Various embodiments of the disclosure may be implemented using a processing device 102, such as, for example, a general-purpose computer, as shown in FIG. 1.

The computer system 100 may include the processing device 102, a display 116, and input devices 120, 122. In addition, the computer system 100 can have any of a number of other output devices including line printers, laser printers, plotters, and other reproduction devices connected to the processing device 102. The computer system 100 can be connected to one or more other computers via a communication interface 108 using an appropriate communication channel 130 such as a modem communications path, a computer network, or the like. The computer network may include a local area network (LAN), a wide area network (WAN), an Intranet, and/or the Internet.

The processing device 102 may comprise a processor 104, a memory 106, input/output interfaces 108, 118, a video interface 110, a supply chain optimization module 112, and a bus 114. Bus 114 may permit communication among the components of the processing device 102.

Processor 104 may include at least one conventional processor or microprocessor that interprets and executes instructions. Memory 106 may be a random access memory (RAM) or another type of dynamic storage device that stores information and instructions for execution by processor 104. Memory 106 may also include a read-only memory (ROM) which may include a conventional ROM device or another type of static storage device that stores static information and instructions for processor 104.

The video interface 110 is connected to the display 116 and provides video signals from the computer 102 for display on the display 116. User input to operate the computer 102 can be provided by one or more input devices 120, 122 via the input/output interface 118. For example, an operator can use the keyboard 120 and/or a pointing device such as the mouse 122 to provide input to the computer 102.

The computer system 100 and processing device 102 may perform such functions in response to processor 104 by executing sequences of instructions contained in a tangible, computer-readable medium, such as, for example, memory 106. Such instructions may be read into memory 106 from another tangible, computer-readable medium, such as a storage device or from a separate device via communication interface 108.

The computer system 100 and processing device 102 illustrated in FIG. 1 and the related discussion are intended to provide a brief, general description of a suitable computing environment in which the invention may be implemented. Although not required, the invention will be described, at least in part, in the general context of computer-executable instructions, such as program modules, being executed by the computer system 100 and processing device 102. Generally, program modules include routine programs, objects, components, data structures, etc. that perform particular tasks or implement particular abstract data types. Moreover, those skilled in the art will appreciate that other embodiments of the invention may be practiced in computer environments with many types of communication equipment and computer system configurations, including cellular devices, mobile communication devices, personal computers, hand-held devices, multi-processor systems, microprocessor-based or programmable consumer electronics, and the like.

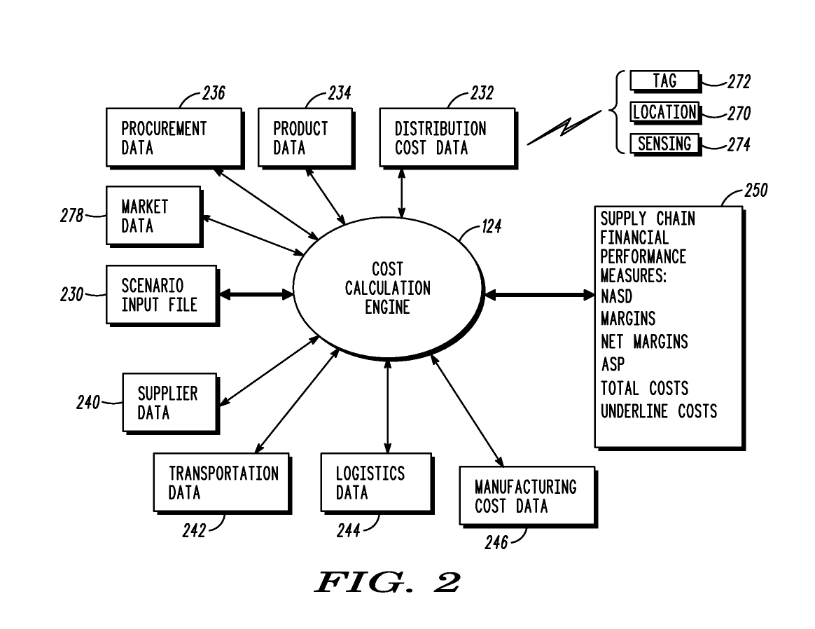

Referring now to FIG. 2, the block diagram illustrates exemplary inputs to and outputs from the cost calculation engine 124. The inputs include a scenario input file 230. The scenario input file 230 may include information pertaining to the products within each market, the source where each product is to be manufactured or distributed for analysis, and the long range plan per product per market. Based on the scenario inputted via the scenario input file 230, the cost calculation engine 124 retrieves appropriate data from various data areas 232-246. The cost calculation engine 124 may then output financial performance information 250 at the market, product, and manufacturing levels.

The cost calculation engine 124 includes classes and functions in place for each of the data types illustrated in FIG. 2. For example, a scenario class is responsible for the management of all class instances for one scenario and the roll-up analysis over all markets or regions in that scenario. The scenario object contains the functions that retrieve the manufacturing and distribution center combined (or separated) cost, margins, and selling prices (average and total) for that specific scenario. The scenario class has one or more instances of duty, manufacturing with distribution center, manufacturing, distribution center, product, and market within its class. The scenario functions retrieve total volume within the region, total and average margin within the region, total and average net sales after discount (“NSAD”), total manufacturing cost and average manufacturing cost per unit, total distribution center cost, and total distribution center cost per unit. The scenario function may save all cost outputs into a text file.

A market class creates an instance of a country-level market. A market instance contains a list of products and the manufacturing, distribution center sources, cost calculation type, volumes, and distributor landed cost for each product. The market class also contains methods for market cost calculation summed across all products. Market functions retrieve, at a market level, volume information, total margin and average margin per unit, total and average net sales after discount, total manufacturing cost, total distribution center cost, and average manufacturing cost per unit and distribution center cost per unit. Market functions retrieve product information such as average selling price, manufacturing cost, and total margin and margin per unit. The market object contains the variables that are the components of average selling price and net sales after discount. The functions present within the object retrieve the manufacturing cost, margins, net sales, and selling prices (average and total). The scenario class has one or more instances of the market within its class, while the market class has one or more instances of product and manufacturing/distribution center within its class.

Depending on the data, the cost calculation engine will support combined manufacturing/distribution center costs or separate manufacturing and distribution center costs. The manufacturing and/or distribution center class will create an instance of manufacturing facility (with distribution center combined or separate), which keeps a list of products that are manufactured or distributed there. Each product is associated with one manufacturing/distribution center cost instance (combined or separate) as its cost calculation engine. Each manufacturing/distribution center instance also contains the facility name, name of country located, manufacturing cost per unit reduction rate, duty information, and other related variables (for example, Penang Radio Transfer Price Multiplier, etc.). The manufacturing and/or distribution center class will provide the function call to get the manufacturing cost per unit of a specific product for one market given the cost calculation type.

The manufacturing/distribution center object contains the variables that are the components of manufacturing cost. In addition, it contains the cost engines for the various cost types, such as, for example, forecast, actual, efficient, and detailed. The functions present within the object may retrieve the manufacturing cost and set the products. The market and scenario classes have one or more instances of manufacturing and/or distribution center within their class, while the manufacturing/distribution center class has one or more instances of duty, manufacturing/distribution center cost, and product within its class. The instructions for the manufacturing/distribution center may set the duty object, the list of products that are manufactured at a given site, cost engines, and volumes, and may retrieve manufacturing cost per unit for one product in one market.

The manufacturing and/or distribution center class may include instructions to decide if any exceptions apply, such as, for example, if any distribution center add-on cost (e.g., sum of battery, antenna, and accessories cost per product) is application, if a Penang margin adjustment is applicable, and/or if a Brazil buy/sell duty cost and/or Brazil Engineering Tax is applicable.

A product class may create an instance of a certain category of product. Each product contains a product name, description and type (either newly-launched or existing), and other related reduction rates. The reduction rates are related to the product over five years. The product object has variables of reduction rates for the various components of manufacturing and the price erosion rate, in addition to the product type (new versus existing). The manufacturing and/or distribution center class, the market class, the manufacturing and/or distribution center cost class, and the scenario class have one or more instances of product within their class.

A duty class will create an instance containing a table of duty rates from different product sources to various destinations within one scenario. The duty class will also contain functions to read the duty rate data file and get the appropriate duty rate percentage for a given pair of source and destination. The duty class may hold a list of product sources and a list of product destinations, as well as holding the duty rates for five consecutive years, for each <source, destination> pair.

The instructions for the duty class include loading duty rates from an input file and retrieving duty rates between two countries. A duty object may include variables of duty rate, destination country, source country, and functions reading the duty rate from the duty rate data file and getting the duty rate for use in any of the classes. The manufacturing/distribution center and scenario classes have one or more instances of duty within their class.

Other classes may be included in the cost calculation engine 124, such as, for example, a transportation class, a supplier class, and a procurement class. The transportation class may create an instance of the current suppliers and manufacturing or distribution center sources and the impact of changes in suppliers for a source and the impact on manufacturing costs (i.e. freight costs for manufacturing and/or distribution center, etc.). The supplier class may create an instance of the current suppliers for a manufacturing source and the impact of movement or changes in suppliers for a source and the impact on manufacturing costs (i.e., direct material costs or warranty costs for manufacturing and/or distribution center, etc.). The procurement class may create an instance of current manufacturing facilities inventory profile and allows evaluation of changes in supplier or manufacturing and distribution center strategies on inventory costs.

FIG. 2 also illustrates how various data sources feed information to the cost calculation engine 124. The data sources may include, for example, location sources 270, tagging sources 272, and/or sensing technologies 274. Tags 272 may store direct material cost data residing at the item stored. Operators can have tags 272 to register to various process areas to gather indirect cost information. Location sources 270 of items, for example, at a workstation or at a warehouse, can be used to feed costing versus work-in-progress costs into inventory. Other sensors, including sensors at workstations or buffers, can report work in progress, downtimes for maintenance and repairs, etc.

For purposes of clarity, the data sources 270, 272, 274 are illustrated feeding the distribution cost data domain 232. It should be appreciated that the data sources 270, 272, 274 may feed the other data domains 230 and 234-246. The data sources 270, 272, 274 may transmit data via network communications or short-range communications, such as, for example, Bluetooth, Zigbee, or the like.

The processor 104 or another processor (not shown) may retrieve information from the data sources 270, 272, 274 for the supply chain optimization module 112. According to various aspects, the supply chain optimization module 112 may select how and when to collect the data from the data sources 270, 272, 274. The optimization module 112 may also selectively monitor conditions to determine when to optimize the supply chain configuration according to cost performance targets. Users may benefit by optimizing real-time data in the current time horizon and using the existing data for planning for the next time horizon.

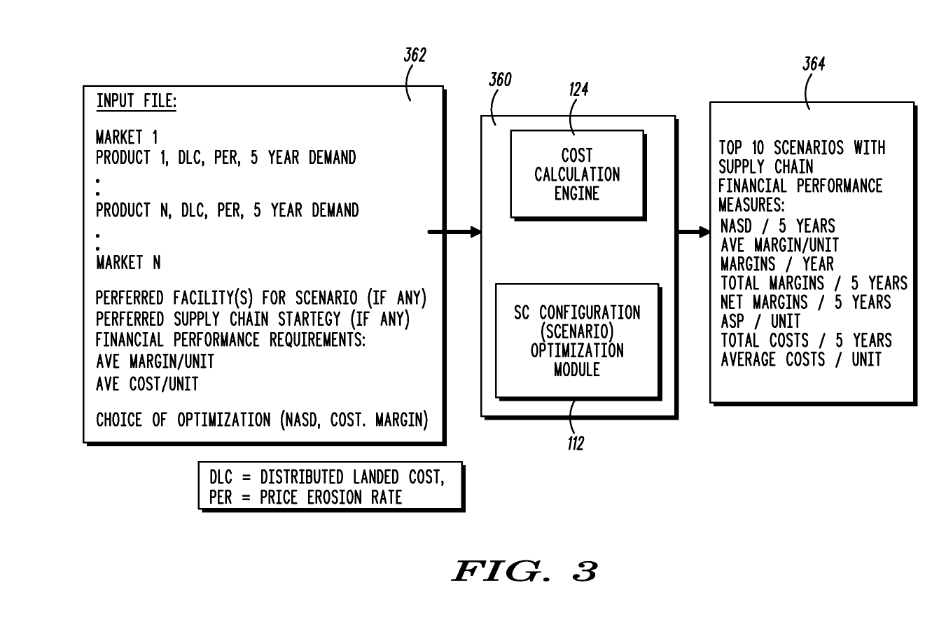

Referring now to FIG. 3, the block diagram illustrates a supply chain cost model 360 that includes the supply chain optimization module 112 in communication with a cost calculation engine, such as, for example, the exemplary cost calculation engine 124 shown and described with respect to FIG. 2. The diagram also illustrates communication of the inputs 362 to and the outputs 364 from the supply chain cost model 360. The supply chain optimization module 112 may include instructions for optimizing a supply chain configuration according to various desired modes of optimization.

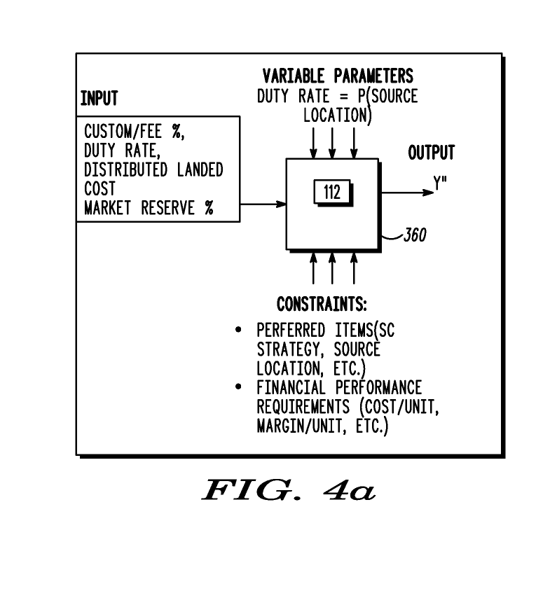

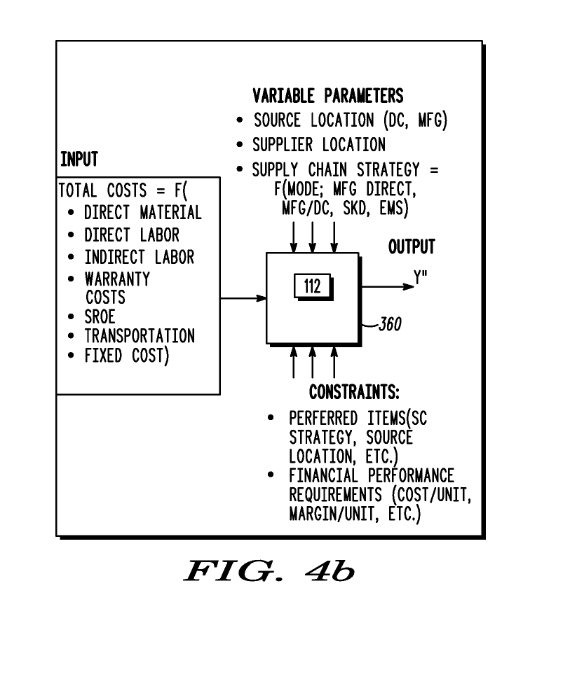

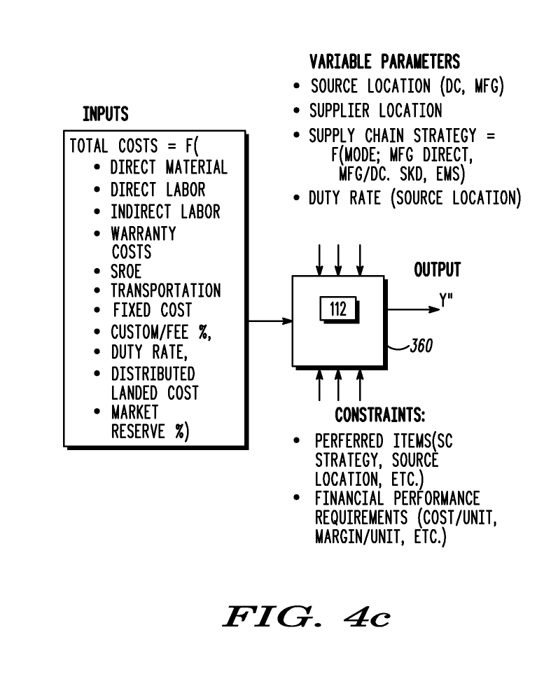

FIGS. 4A-4C illustrate three modes of optimization and the inputs, outputs, and constraints of each. FIG. 4A is a block diagram showing a supply chain cost model 360 including supply chain cost model 112 with instructions for maximizing net sales. FIG. 4B is a block diagram showing a supply chain cost model 360 including supply chain cost model 112 with instructions for minimizing costs. FIG. 4C is a block diagram showing a supply chain cost model 360 including supply chain cost model 112 with instructions for maximizing margin.

As illustrated in FIG. 4A, the supply chain optimization module 112 may be instructed to optimize a supply chain configuration to maximize net sales after discount (“NSAD”) and output the optimized figures and associated supply chain configurations. The inputs for such an optimization process may include custom/fee percentage, duty rate, distributed landed cost, and market reserve percentage. The constraints on the optimization process may include preferred items (e.g., supply chain strategy, source location, and the like) and financial performance requirements (e.g., cost per unit, margin per unit, and the like). The optimization process may include a variable parameter, such as, for example, duty rate, which is a function of the source location.

Referring now to FIG. 4B, the supply chain optimization module 112 may be instructed to optimize a supply chain configuration to minimize costs, such as, for example, manufacturing cost per unit (“MCPU”) and/or distribution center cost per unit (“DCCPU”) and output the optimized figures and associated supply chain configurations. The inputs for such an optimization process may include total costs, which are a function of direct material, direct labor, indirect labor, warranty costs, SROE, transportation, and fixed costs. The constraints on the optimization process may include preferred items (e.g., supply chain strategy, source location, and the like) and financial performance requirements (e.g., cost per unit, margin per unit, and the like). The optimization process may include variable parameters, such as, for example, source location (e.g., distribution center, manufacturing, etc.), supplier location, and supply chain strategy. The supply chain strategy may be a function of the supply chain mode, such as, for example, manufacturing direct, manufacturing/distribution center, semi-knockdown, or external sourcing.

As shown in FIG. 4C, the supply chain optimization module 112 may be instructed to optimize a supply chain configuration to maximize margin and output the optimized figures and associated supply chain configurations. The inputs for such an optimization process may include total costs, which are a function of direct material, direct labor, indirect labor, warranty costs, SROE, transportation, fixed costs, custom/fee percentage, duty rate, distributed landed cost, and market reserve percentage. The constraints on the optimization process may include preferred items (e.g., supply chain strategy, source location, and the like) and financial performance requirements (e.g., cost per unit, margin per unit, and the like). The optimization process may include variable parameters, such as, for example, source location (e.g., distribution center, manufacturing, etc.), supplier location, duty rate, which is a function of the source location, and supply chain strategy. The supply chain strategy may be a function of the supply chain mode, such as, for example, manufacturing direct, manufacturing/distribution center, semi-knockdown, or external sourcing.

For illustrative purposes, an exemplary supply chain optimization process of the supply chain optimization module 112 will be described below in relation to the block diagrams shown in FIGS. 1-4C.

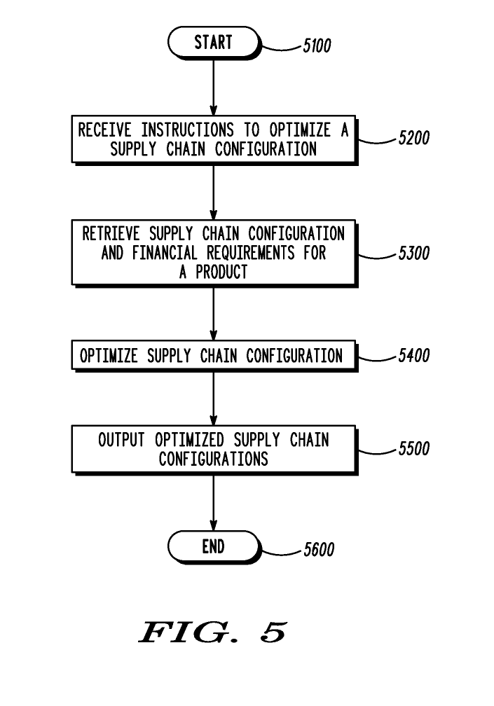

FIG. 5 is a flowchart illustrating some of the basic steps associated with an exemplary supply chain optimization process in accordance with a possible embodiment of the invention. The process begins at step 5100 and continues to step 5200 where the supply chain optimization module 112 receives instructions to optimize a supply chain configuration. The instructions may include user inputs such as, for example, a desired supply chain strategy, a desired manufacturing and/or distribution facility, and/or a choice of optimization type. The optimization type may include one of maximum margin, maximum net sales after discount, and minimum costs. Control then proceeds to step 5300.

In step 5300, the supply chain optimization module 112 retrieves a supply chain configuration and financial requirements for a product to be optimized. The supply chain configuration may include any user inputs received. The process continues to step 5400, where the supply chain optimization module 112 cooperates with the cost calculation engine 124 to determine a supply chain configuration that best satisfies the input optimization type over a desired period of time. For example, if the optimization type is maximum margin, the optimization module 112 may determine one or more supply chain configurations that best maximize the margin over a desired period of time over a period of several years.

The process of step 5400 may include various sub-processes. For example, the optimization process achieved by the optimization module 112 and the cost calculation engine 124 may include retrieving information from various supply chain domains, such as, for example, procurement, supplier, transportation, logistics, distribution, manufacturing, and market. Step 5400 may further include conducting a sensitivity analysis and/or performing cross-scenario comparisons relative to the supply chain configuration. In addition, the optimization module may evaluate at least one additional supply chain configuration by, for example, varying one or more supply chain strategies. The supply chain strategies may include combined manufacturing and distribution center, separate manufacturing and distribution centers, external sourcing, complete knockdown, and semi-knockdown. Control then continues to step 5500.

In step 5500, the supply chain optimization module 112 outputs one or more supply chain configurations that best achieve the optimization objective. For example, if the optimization type is maximum margin, the module 112 may output ten supply chain configurations that best maximize margin over a five year period. Control proceeds to step 5600 where the process ends.

It should be appreciated that the exemplary cost calculation engine 124 may be configured to verify a supply chain configuration with respect to costs and understand where cost-over runs are occurring prior to release to manufacturing. The supply chain optimization model 112 may include instructions for evaluating costs with respect to product design (e.g., Direct Material, Direct Labor (DFA, DFM), etc.), networks (e.g., Transportation, Supplier, Manufacturing and Distribution, Logistics, etc.), and market parameters (e.g., duty, tax, long range planning, demand, etc.). If, according to the cost calculation engine 124, the financial performance of the supply chain configuration does not meet projections, the supply chain optimization module 112 may making various changes to the supply chain configuration changes prior to releasing product to manufacturing is crucial in satisfying one pass to customer design.

It should be appreciated that the processing device 102 may provides users with market, product and sourcing views of the information and outputs. Thus, the user can view financial performance outputs at the market, product and sourcing levels of the supply chain configuration. The instructions of the processing device 102 may support. products within all phases of the lifecycle, from marketing requirements life cycle through to product retirement. The instructions may support multiple cost and data types, such as, for example, forecasted, actual, contract book, marketing requirements document, and derived cost data.

The instructions may support some manufacturing strategies that impact cost and revenues may include lean, efficient, detailed manufacturing costs using fixed cost/volume profiles applied to multiple cost types do not exist. The instructions may also support distribution strategies internal to the center that impact cost and revenues, such as, for example, ABC classification, order processing mechanisms, etc. The manufacturing costs show the impact of implementing various manufacturing strategies and distribution center strategies on overall costs.

The instructions may support supply chain strategies such as, for example, bypassing distribution center, external sourcing, semi-knock down, complete knock down. The supply chain optimization module supports the above strategies if indicated in the input scenario file. Instructions of the processing device 102 may support changing a baseline scenario, modeling increases/decreases in parameters (e.g., volume, direct material costs, fixed costs, etc.), and saving scenarios as separate entities. The instructions may support simulating supplier changes and/or a new manufacturing facility and/or distribution center, and the impact on product financial performance.

Embodiments within the scope of the present disclosure may also include computer-readable media for carrying or having computer-executable instructions or data structures stored thereon. Such computer-readable media can be any available media that can be accessed by a general purpose or special purpose computer. By way of example, and not limitation, such computer-readable media can comprise RAM, ROM, EEPROM, CD-ROM or other optical disk storage, magnetic disk storage or other magnetic storage devices, or any other medium which can be used to carry or store desired program code means in the form of computer-executable instructions or data structures. When information is transferred or provided over a network or another communications connection (either hardwired, wireless, or combination thereof) to a computer, the computer properly views the connection as a computer-readable medium. Thus, any such connection is properly termed a computer-readable medium. Combinations of the above should also be included within the scope of the computer-readable media.

Computer-executable instructions include, for example, instructions and data which cause a general purpose computer, special purpose computer, or special purpose processing device to perform a certain function or group of functions. Computer-executable instructions also include program modules that are executed by computers in stand-alone or network environments. Generally, program modules include routines, programs, objects, components, and data structures, etc. that perform particular tasks or implement particular abstract data types. Computer-executable instructions, associated data structures, and program modules represent examples of the program code means for executing steps of the methods disclosed herein. The particular sequence of such executable instructions or associated data structures represents examples of corresponding acts for implementing the functions described in such steps.

It will be apparent to those skilled in the art that various modifications and variations can be made in the devices and methods of the present disclosure without departing from the scope of the invention. Other embodiments of the invention will be apparent to those skilled in the art from consideration of the specification and practice of the invention disclosed herein. It is intended that the specification and examples be considered as exemplary only.

What is claimed is:

1. A machine-implemented method for optimizing a supply chain configuration, the method comprising:
retrieving a supply chain configuration and financial requirements for a product;
receiving user input to optimize the supply chain configuration; and
outputting at least one most profitable scenario based on a desired time period.

2. The method of claim 1, further comprising retrieving information from supply chain domains via at least one data source.

3. The method of claim 2, wherein the at least one data source comprises at least one of a tag, a sensor, and a location source, and the information is retrieved via at least one of a short range communication and a network communication.

4. The method of claim 1, further comprising at least one of conducting a sensitivity analysis and performing cross-scenario comparisons.

5. The method of claim 1, further comprising evaluating at least one additional supply chain configuration.

6. The method of claim 5, further comprising varying at least one of a plurality of supply chain strategies, said supply chain strategies including combined manufacturing and distribution center, separate manufacturing and distribution centers, external sourcing, complete knockdown, and semi-knockdown.

7. The method of claim 1, wherein the user input includes at least one of a desired supply chain strategy, a desired facility, and an optimization type, the optimization type comprising one of maximum margin, maximum net sales after discount, and minimum costs.

8. A processing device comprising:
at least one processor;
a memory including instructions for the processor; and
a bus for providing communication between the processor and the memory, the memory further comprising instructions for retrieving a supply chain configuration and financial requirements for a product, receiving user input to optimize the supply chain configuration, and outputting at least one most profitable scenario based on a desired time period.

9. The processing device of claim 8, wherein the memory further comprises instructions for retrieving information from supply chain domains via at least one data source.

10. The processing device of claim 9, wherein the at least one data source comprises at least one of a tag, a sensor, and a location source, and the information is retrieved via at least one of a short range communication and a network communication.

11. The processing device of claim 8, wherein the memory further comprises instructions for at least one of conducting a sensitivity analysis and performing cross-scenario comparisons.

12. The processing device of claim 8, wherein the memory further comprises instructions for evaluating at least one additional supply chain configuration.

13. The processing device of claim 11, wherein the memory further comprises instructions for varying at least one of a plurality of supply chain strategies, said supply chain strategies including combined manufacturing and distribution center, separate manufacturing and distribution centers, external sourcing, complete knockdown, and semi-knockdown.

14. The processing device of claim 8, wherein the user input includes at least one of a desired supply chain strategy, a desired facility, and an optimization type, the optimization type comprising one of maximum margin, maximum net sales after discount, and minimum costs.

15. A tangible, machine-readable medium having instructions for at least one processor recorded thereon, the medium comprising:
instructions for retrieving a supply chain configuration and financial requirements for a product;
instructions for receiving user input to optimize the supply chain configuration; and
instructions for outputting at least one most profitable scenario based on a desired time period.

16. The medium of claim 15, wherein the memory further comprises instructions for retrieving information from supply chain domains via at least one data source,
wherein the at least one data source comprises at least one of a tag, a sensor, and a location source, and the information is retrieved via at least one of a short range communication and a network communication

17. The medium of claim 15, wherein the memory further comprises instructions for at least one of conducting a sensitivity analysis and performing cross-scenario comparisons.

18. The medium of claim 15, wherein the memory further comprises instructions for evaluating at least one additional supply chain configuration.

19. The medium of claim 18, wherein the memory further comprises instructions for varying at least one of a plurality of supply chain strategies, said supply chain strategies including combined manufacturing and distribution center, separate manufacturing and distribution centers, external sourcing, complete knockdown, and semi-knockdown.

20. The medium of claim 15, wherein the user input includes at least one of a desired supply chain strategy, a desired facility, and an optimization type, said optimization type comprising one of maximum margin, maximum net sales after discount, and minimum costs.
